(19) United States
(12) Patent Application Publication
(10) Pub. No.: US 2025/0226251 A1
(43) Pub. Date: Jul. 10, 2025

(54) METHOD AND APPARATUS FOR DETERMINING CONTRIBUTION OF FACTOR DURING MANUFACTURING OF WAFER

(71) Applicant: Samsung Electronics Co., Ltd., Suwon-si (KR)

(72) Inventors: Young Hwan JEON, Suwon-si (KR); Namyeong KWON, Suwon-si (KR)

(73) Assignee: Samsung Electronics Co., Ltd., Suwon-si (KR)

(21) Appl. No.: 19/009,309

(22) Filed: Jan. 3, 2025

(30) Foreign Application Priority Data
Jan. 4, 2024 (KR) 10-2024-0001687

(51) Int. Cl. H01L 21/67

(52) U.S. Cl. CPC H01L 21/67288

(57) ABSTRACT

A method, a device, and a system that determines a plurality of partial contributions from process data of a target wafer and process data of a background set wafer to a yield using a trained yield prediction model, and determines a contribution of a factor in a manufacturing process of the target wafer to the yield by summing the plurality of partial contributions are provided.

### CROSS-REFERENCE TO RELATED APPLICATION

This application claims priority to and the benefit of Korean Patent Application No. 10-2024-0001687 filed in the Korean Intellectual Property Office on Jan. 4, 2024, the entire contents of which are incorporated herein by reference.

### BACKGROUND OF THE INVENTION

### 1. Field of the Invention

The present disclosure relates to a method and a device for determining contribution of factors, that are present during a wafer manufacturing process, to wafer yield of the manufacturing process.

### 2. Description of the Related Art

The Shapley value has found recent application in machine learning. For example Shapley values of input features of an artificial intelligence (AI) model may be used as indications of which input features, or combinations of input features, are most important to an AI model's predictions. In general, considering chip manufacturing as an example, given a set of manufacturing-affecting factors (e.g., input features) and an AI model, the Shapley value of each factor/feature may be determined based on a difference between predictions results of an AI model with and without each factor. When input data has N factors/features, training the AI model may involve a large amount of calculations (e.g., ˜2N) to accurately calculate the Shapley values of the respective factors/features.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for analyzing a yield of a target wafer includes: converting an indication of a category among process data of the target wafer into a first embedding vector comprised of elements and converting indications of the category among process data of background-set wafers into second embedding vectors comprised of elements; determining partial contributions, with respect to the yield, of the respective elements of the first embedding vector through differentiation with respect to a yield prediction model, the yield prediction model configured to predict yields of wafers from embedding vectors thereof; and determining a contribution, to the yield, of a factor in a manufacturing process of the target wafer based on combining the partial contributions of the elements of the first embedding vector, the factor corresponding to the indicated category of the target wafer.

The target wafer may be a fabrication-out wafer selected based on an actual yield thereof or may be an in-fabrication wafer selected based on a predicted yield thereof predicted by the yield prediction model before the manufacture of the target wafer is completed.

The process data of the background-set wafers may include data of fabrication-out wafers having respective yields exceeding a predetermined reference.

The converting the indication of the category among the process data of the target wafer into the first embedding vector and converting the indications of the category among the process data of the background-set wafers into the second embedding vectors may include: converting the indication of the category among the process data of the target wafer into a first number; converting the indications of the category among the process data of the background-set wafers into second numbers; and converting the first number into the first embedding vector and the second numbers into the second embedding vectors using an embedding layer of a neural network model.

The determining the partial contributions may include calculating an expected gradient of the elements of the first embedding vector based on an instantaneous change rate of the yield prediction model for the elements of the first embedding vector.

The calculating the expected gradient of the elements of the first embedding vector may include: determining points between process data of fabrication-out wafers included in the background-set wafers and the process data of the target wafer; and determining the instantaneous change rate of the yield prediction model for the elements of the first embedding vector at the points.

The calculating the expected gradient of the elements of the first embedding vector may further include: calculating the expected gradient by multiplying a difference between an element of the first embedding vector and corresponding elements of the second embedding vectors of corresponding factors of the fabrication-out wafers by the instantaneous change rate of the yield prediction model.

In another general aspect, a system for analyzing a yield of a wafer includes: an embedding layer configured to convert, into an embedding vector, an indication of a category corresponding to one of multiple factors of a manufacturing process of manufacturing the wafer; and a model explainer configured to determine contribution, to the yield, of the factor corresponding to the indicated category of the wafer based on a change rate of a yield prediction model.

The system may further include an encoder configured to convert the indication of the category into a number, and the embedding layer may be further configured to convert the number into the embedding vector.

The wafer may be a fabrication-out wafer having an actual yield or may be an in-fabrication wafer having a predicted yield predicted by the yield prediction model before the wafer is done being manufactured, and the wafer may be selected based on the actual yield or the predicted yield.

The model explainer may be further configured to determine partial contributions of elements included in the embedding vector based on the change rate of the yield prediction model and determine contribution of the factors to the yield by combining the partial contributions of the elements.

When determining the partial contributions of the elements, the model explainer may be further configured to calculate an expected gradient of the elements based on an instantaneous change rate of the yield prediction model for the elements.

When calculating the expected gradient of the elements, the model explainer may be further configured to randomly determine points between process data of background-set wafers and the process data of the wafer and determine the instantaneous change rate of the yield prediction model for the elements of the embedding vector corresponding to the factor at the points.

When calculating the expected gradient of the elements, the model explainer may be further configured to calculate the expected gradient by multiplying a difference between the element of the embedding vector corresponding to the factor and corresponding elements of embedding vectors of corresponding factors of the background-set wafers by the instantaneous change rate of the yield prediction model.

In another general aspect, an apparatus for analyzing a yield of a wafer includes one or more processors and memory, the memory storing instructions configured to cause the one or more processors to perform a process including: converting categorical data among process data of the wafer into an embedding vector; determining contributions of factors respectively corresponding to the categorical data to the yield based on a change rate of a yield prediction model for the embedding vector; and determining a primary factor among the factors based on the contributions.

The determining the primary factor among the factors based on the contributions may include determining at least one factor having a lower contribution than a predetermined reference among the factor as the primary factor.

The determining the primary factor among the factors based on the contributions may include determining at least one factor as the primary factor in an order of smallest contribution.

The process may further include: converting categorical data among process data of a background set wafer for the wafer into an embedding vector, and the background set wafer includes fabrication-out wafers having respective yields exceeding a predetermined reference.

The converting categorical data among process data of the wafer into an embedding vector may include: converting the categorical data in the process data into numeric data; and converting the numeric data into the embedding vector.

The determining the contributions of factors respectively corresponding to the categorical data to the yield based on a change rate of a yield prediction model for the embedding vector may include determining partial contributions of elements included in the embedding vector to the yield based on the change rate of the yield prediction model for the embedding vectors; and determining the contributions of the factors to the yield by summing the partial contributions of the elements.

Other features and aspects will be apparent from the following detailed description, the drawings, and the claims.

### BRIEF DESCRIPTION OF THE DRAWINGS

FIG. 1 illustrates a yield analysis system according to one or more embodiments.

FIG. 2 illustrates categorical data in a semiconductor manufacturing process according to one or more embodiments.

FIG. 3 illustrates a yield prediction method according to one or more embodiments.

FIG. 4 illustrates a contribution calculation method of a model explainer according to one or more embodiments.

FIG. 5 illustrates a partial contribution calculation method of the model explainer according to one or more embodiments.

FIG. 6 illustrates a neural network according to one or more embodiments.

FIG. 7 illustrates a yield analysis device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

In computing Shapley values, to avoid the kind of 2^{N} computational demand discussed in the Background, methods to approximately calculate a theoretically defined Shapley value may be used. For example, Shapley Additive explanations (SHAP) may be used to calculate an approximation of the Shapley value.

An AI model according to according to one or more embodiments described herein may be/include a physical (machine-implemented) learning model that learns at least one task, and may be implement as a computer program (instructions) executed by a processor. A “task” learned by the AI model may refer to a task to be solved through machine learning or a task to be performed through machine learning. The AI model may be implemented as a computer program (instructions) running on a computing device, downloaded through a network, or sold in product form. Alternatively, the AI model may be linked with various devices through the network.

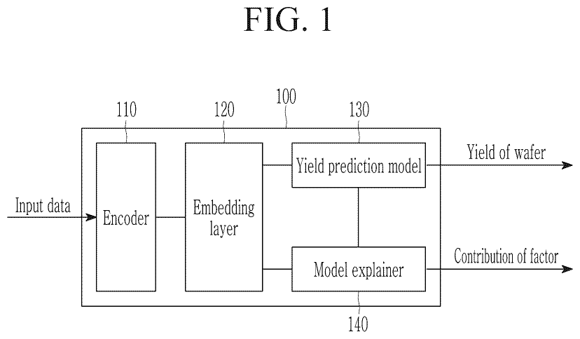

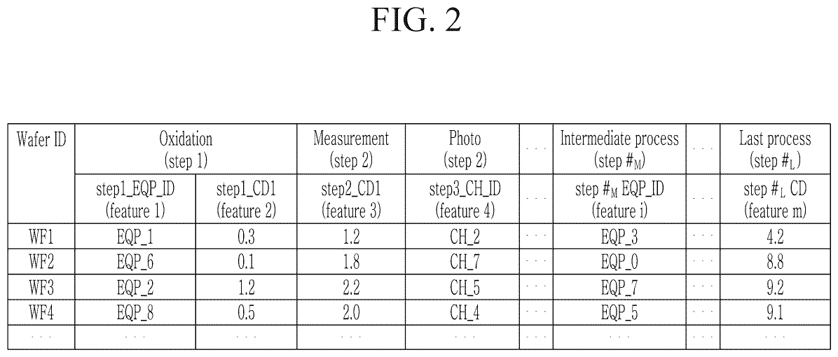

FIG. 1 illustrates a yield analysis system according to one or more embodiments, and FIG. 2 illustrates categories in a semiconductor manufacturing process according to one or more embodiments. Unless the context suggests otherwise, “category” will refer to a particular category and is short for “category value” (a value indicating a particular category).

A yield analysis system 100 according to one or more embodiments may analyze product data of a product and calculate contribution of a specific factor in the product data during a manufacturing process of the product to the yield of the product. The product may include a wafer in a semiconductor manufacturing process, as a non-limiting example. Hereinafter, an example of an analysis of the yield of a wafer in the semiconductor manufacturing process by the yield analysis system 100 will be described, however, the techniques described herein may be readily applied to other manufacturing processes, e.g., alloy manufacturing.

When a particular wafer being manufactured goes through numerous manufacturing process steps, wafer data for the corresponding particular wafer may be generated. Wafer data specific to the respective steps that produced the particular wafer may also be generated. The wafer data may include information about at least one process facility used in the process step (e.g., information identifying a particular facility) and the information about the process facility may be categorical data (e.g., a category of the facility). In each process step, multiple process facilities may be used, for example, in one process step a manufacturing facility, chamber, and/or reticle may be used; each such process facility used in a process step may function as a factor that affects the yield of the particular wafer produced therewith.

Categorical data of the process facilities may include an identifier (ID) of a facility used during the semiconductor process. For example, the categorical data may include an identifier of a manufacturing facility such as EQP_1, an identifier of a chamber such as CH_1, and/or an identifier of a reticle such as RTC_1 (see FIG. 2 for other examples).

To understand wafer yield, as a non-limiting example, the yield of a wafer may be computed as the ratio of good chips manufactured from the wafer among the total number of chips manufactured from the wafer. For example, when 100 total chips are produced on a wafer and a fabrication-out wafer is found to contain 95 good chips among the 100, the yield of that wafer may be 95%.

A fabrication-out wafer is a wafer where all relevant fabrication processes have been completed and the yield has been determined, and an in-fabrication wafer is a wafer where processing/fabrication is still in progress. The yield of the fabrication-out wafer may be determined in an electrical die sorting (EDS) process. Yield information of an individual fabrication-out wafer may include an identifier of the fabrication-out wafer and, associated therewith, the number of good chips on the corresponding fabrication-out wafer.

Referring to FIG. 1, the yield analysis system 100 according to one or more embodiments may include an encoder 110, an embedding layer 120, a yield prediction model 130, and a model explainer 140.

For a chip manufacturing process, for example, process steps thereof may have respective process data; a process step's process data may include a category thereof (e.g., a category of equipment). The encoder 110 may encode indications of categories among the process data of each process step into respective numbers. The numbers may be integers greater than 0 (or non-negative integer). For example, supposing that x manufacturing facilities (each having y chambers), are used in performing one process step of manufacturing wafers (any one wafer might be processed by any one of the x facilities and any one of that facility's y chambers), to represent/encode each unique facility-chamber combination (of which there may be x*y), the indications, in the process data, of the x manufacturing facilities and the y chambers may each be encoded with a corresponding uniquely identifying number from 0 to (x*y).

Each wafer may be fabricated out through several processes, such as an oxidation process and a measurement process (which can vary in detail from wafer to wafer). The process data of a fabrication-out wafer may be assumed to include m features that occurred during the manufacturing process of the wafer, including at least some categories, as mentioned above. The process data of a fabrication-out wafer WF_{FAB-OUT} including m features may be represented in a form shown in Equation 1 below.

WF_{FAB-OUT}:[α₁,α₂, . . . ,αᵢ, . . . ,αₘ] Equation 1

Referring to the example process data of multiple wafers shown in FIG. 2, when a wafer WF1 goes through an oxidation process step by equipment EQP_1 and an intermediate process step by equipment EQP_3, the process data of WF1 may include respective categories EQP_1 and EQP_3. Equation 2 below represents the process data of WF1 in the form of Equation 1, which is an initial form before encoding and embedding.

WF1:[EQP_1,0.3,1.2,CH_2, . . . , EQP_3, . . . , 4.2] Equation 2

In Equation 2, the process data includes both categories and numeric data. The number of elements in the process data may be equal to the number of features m. When there is a count of z elements/features of numeric data in the process data, the count of features in the process data that are categories is m-z. When the encoder 110 converts/encode the categories (but not numeric data) from the process data of WF1 (Equation 2) into respectively corresponding numbers, the resulting process data of WF1 may be in the form of Equation 3 below.

WF1:[1,0.3,1.2,12, . . . ,3, . . . 4.2] Equation 3

Referring to Equation 3, EQP_1 in Equation 2 is converted to 1, CH_2 is converted to 12, and EQP_3 is converted to 3. In short, each category may be converted to a unique identifier, similar to an index. In some embodiments, the encoder 110 may convert the categories into their respective numbers according to a predetermined rule, and each category within the entire feature (process data) may be uniquely identified its number as converted by the encoder 110. For example, when there are p valid categories in the entire manufacturing process, there may also be p respective numbers to which the categories are converted by the encoder 110 for a given wafer.

In some embodiments, the embedding layer 120 may convert the category number encodings, specifically, in the process data into respective embedding vectors. The embedding layer 120 may convert the numeric data encoded by the encoder 110 into an embedding vector in a multi-dimensional embedding space. The larger the dimension of the embedding space, the better the information of the categories can be reflected. For example, the embedding vectors may be within a four-dimensional embedding space. Process data, in the form of an embedding vector (converted by the embedding layer 120) may be used as input for the yield prediction model 130 and the model explainer 140.

In some embodiments, the yield analysis system may directly convert the categories of the semiconductor manufacturing process into embedding vectors.

As noted, the embedding layer 120 may convert the category-representing numbers (converted from the categories) into respective embedding vectors. Referring to the example of Equation 2, the embedding layer 120 converts the first feature/category, the fourth feature/category, and the i-th feature/category of WF1's process data into respective embedding vectors. Equation 4 is an example of the process data of WF1 after categories have been converted to respective embedding vectors by the embedding layer 120.

WF1:[(0.62,0.17,0.89,0.43),0.3,1.2,(0.73,0.42,0.91,0.58), . . . ,(0.76,0.28,0.51,0.93), . . . ,4.2] Equation 4

In some embodiments, the embedding layer 120 may convert the numeric identifier of a category into an embedding vector having numbers in a predetermined range (e.g., 0 to 1) as elements of the embedding vector. In Equation 4, the embedding layer 120 has converted the first element 1 of Equation 3 to (0.62,0.17,0.89,0.43), the fourth element 12 of Equation 3 to (0.73,0.42,0.91,0.58), and the i-th element 3 of Equation 3 to (0.76,0.28,0.51,0.93).

The number of elements included in each wafer's process data preprocessed by the encoder 110 and the embedding layer 120 may be represented as per Equation 5 below.

$$f + ( m - f ) \times d \qquad Equation 5$$

In Equation 5, m represents the number of elements in the original process data, f represents the number of numeric data such as measurement data among original process data, and d is the number of dimensions of the embedding space.

In some embodiments, when data aᵢ of an i-th feature among m features in the process data of a wafer is a category type of data, the encoder 110 and the embedding layer 120 may convert the category data aᵢ into an embedding vector xᵢ having d-dimensions as in Equation 6 below.

aᵢ→xᵢ=(x_{i,1},x_{i,2}, . . . ,x_{i,j}, . . . ,x_{i,d}) Equation 6

In some embodiments, the yield prediction model 130 may be trained through supervised learning using process data of fabrication-out wafers and ground-truth yield information of the fabrication-out wafers. The process data of the fabrication-out wafers input to the yield prediction model 130 may include embedding vectors of the categories. The yield prediction model 130 may be an AI model (e.g., a neural network) that updates parameters through a supervised learning scheme by comparing a prediction result output from the input data with a label of the input data and performing, for example, backpropagation using gradient descent to update parameters (e.g., weights, biases, etc.) of the AI model.

For example, when the process data of a fabrication-out wafer is inputted to the yield prediction model 130, the yield prediction model 130 performs an inference thereon and outputs a yield prediction value through neural network processing of the input process data; parameters (including weights and/or biases) are updated by comparing the predicted yield value with the actual ground-truth yield of the fabrication-out wafer. Such training may be performed for many fabrication-out wafers.

The trained yield prediction model 130 may be used to predict the yield of wafers undergoing processing (in-fabrication wafers). For example, the trained yield prediction model 130 may predict the yield of an in-fabrication wafer by performing inference on process data of the in-fabrication wafer inputted to the prediction model 130. The process data of the in-fabrication wafer inputted to the trained yield prediction model 130 may include an embedding vector converted from category data.

In some embodiments, the model explainer 140 may determine contributions of factors of a target wafer to the yield of the target wafer through differentiation with respect to the yield prediction model 130. For example, the model explainer 140 may determine the contributions of each of the factors to the yield of a fabrication-out wafer (which has been determined to have a low yield) through differentiation with respect to the yield prediction model 130. Alternatively, the model explainer 140 may determine the contributions of factors of the in-fabrication wafer to the predicted yield by differentiating with respect to the yield prediction model 130.

In some embodiments, the model explainer 140 may determine the contributions of the respective factors included in the input data to an inference result of the yield prediction model by calculating the Shapley value.

The model explainer 140 may determine a background set (e.g., WF_{bg_1} to WF_{bg_n}) to calculate contributions, of factors of an analysis target (e.g., a wafer), to a predicted result, and may do so by utilizing Shapley Additive explanations (SHAP). With the SHAP technique, a factor (e.g., a feature of a wafer such as an embedding vector as per above) of an analysis target is replaced with an average value of corresponding factors in a background set. This may be done for each factor/feature of the analysis target. The contribution of any factor to the predicted result of the analysis target may be calculated based on variation in the predicted result when the factor of the target is replaced with the average value of the corresponding factors in the background set.

In general, a prior sampling explainer may determine contributions of respective factors of the analysis target for a predicted result. In the prior sampling explainer, a factor of the target is replaced by factors in the background set, rather than using a statistic such as an average of corresponding factors in the background set, the prior sampling explainer generates multiple corresponding samples of the target (e.g., replacing the target's factor with corresponding factors in the background set), and the contribution of the target's factor may be determined based on the predicted values of the respective samples. However, since this approach involves predicting results for many samples (e.g., a model inference for each sample), the overall computation of the sampling explainer may be costly and time-consuming.

In some embodiments, the model explainer 140 may use a gradient explainer to reduce the computational demands of the prior sampling explainer. The gradient explainer may approximate the Shapley value by (i) differentiating a differentiable prediction model for a factor to obtain a sensitivity function and (ii) calculating an expected gradient based on the sensitivity function that changes when the factor of the background set moves in the direction of the factor of the analysis target. In general, the gradient explainer uses a numeric input to compute the expected gradient, and thus the yield analysis system 100 may transform the categorical data into the embedding vector using the encoder 110 and the embedding layer 120 to utilize the gradient explainer, and input the process data including the embedding vector to the model explainer 140.

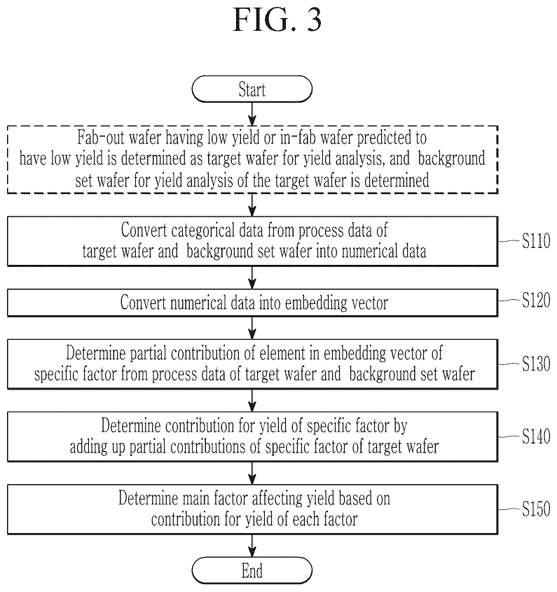

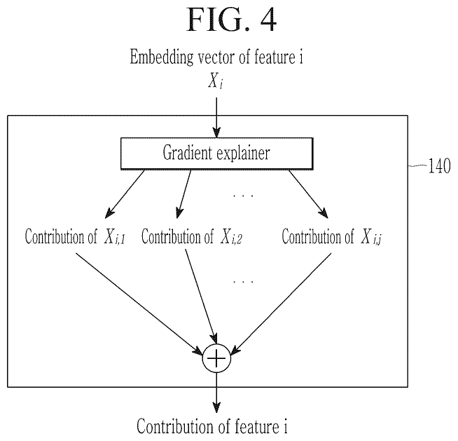

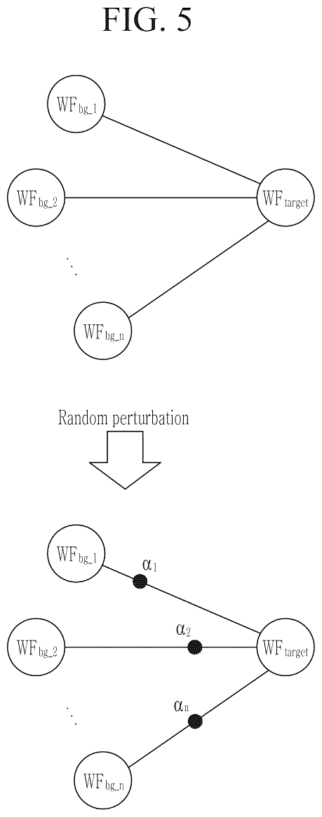

FIG. 3 illustrates a yield prediction method according to one or more embodiments, FIG. 4 illustrates a contribution calculation method of a model explainer according to one or more embodiments, and FIG. 5 illustrates a partial contribution calculation method of the model explainer according to one or more embodiments.

Referring to FIG. 3, a fabrication-out wafer having a low yield among multiple fabrication-out wafers may be selected as a target wafer for yield analysis. Alternatively, an in-fabrication wafer predicted to have a low yield during the process may be selected as a target wafer for the yield analysis.

In some embodiments, a background set including data of a plurality of fabrication-out wafers may be determined and then used to analyze a reason that a target wafer had a low yield or to analyze a reason that a low yield was predicted for a target wafer. The background set of wafer data may include data of fabrication-out wafers that have an excellent yield (e.g., a yield exceeding a predetermined reference). The background set of wafer data may be selected from among wafers that are fabricated out in close proximity to the time at which the target wafer is/was fabricated. Alternatively, the background set of wafer data may be selected from among fabrication-out wafers with a factor regarding recently installed process equipment.

In some embodiments, the yield analysis system 100 may determine a factor of a target wafer that has the greatest impact on a corresponding low yield by determining contribution of each of multiple factors of the target wafer to the yield. Referring to FIG. 3, the yield analysis system 100 may convert all process data into numerical data by converting the categories in the process data of the wafer into an embedding vector in order to determine the contribution of the factor to the yield.

The encoder 110 of the yield analysis system 100 may encode the categories from the process data of the target wafer and the background set of wafer data into numbers (S110). The encoder 110 may encode occurrences of a same category data into a same number and different categories into different numbers.

The embedding layer 120 of the yield analysis system 100 may convert the encoded category numbers into embedding vectors (S120). Each element of an embedding vector may be a positive real number, and the size of each element may be determined within a predetermined range (e.g., between 0 and 1).

The model explainer 140 of the yield analysis system 100 may determine the sum of partial contributions of elements in the embedding vector of each factor of the target wafer as the contribution corresponding to each factor of the target wafer. Next, referring to FIG. 4 and FIG. 5, a method for the model explainer 140 to determine contribution of each factor of the target wafer will be described in detail.

Referring to FIG. 3 and FIG. 4, the model explainer 140 may determine a partial contribution of each element of embedding vector xᵢ (representative of each embedding vector) corresponding to a feature i (of an analysis target) using at least one gradient explainer (S130).

An Expected gradient_{i,j} (WF_{target}) of a j-th element of the embedding vector corresponding to an i-th factor of the target wafer (i.e., partial contribution determined for each element of the embedding vector) may be determined as Equation 7 below. To summarize, the target wafer (analysis target) may have multiple factors, some of which are embedding vectors, and each embedding vector has multiple elements, partial contributions of which may be respectively determined.

$$( “ WF ” means “ wafer ” , “ bg ” means “ background ” ) \\ Expected {Gradient}_{i , j} ( W {F}_{target} ) = {E}_{W {F}_{b g} ∼ Background , α ∼ U [ 0 , 1 ]} [ \text{} ( {x}_{i , j} - {( W {F}_{bg} )}_{i , j} ) \cdot \frac{\partial f ( W {F}_{bg} + α ( W {F}_{t a r g e t} - W {F}_{bg} ) )}{\partial {x}_{i , j}} ] ≃ {\sum }_{k = 1}^{n} ( {x}_{i , j} - {( W {F}_{b g} )}_{i , j} ) \cdot \frac{\partial f ( W {F}_{b {g}_{k}} + {α}_{k} ( W {F}_{t a r g e t} - W {F}_{{bg}_{k}} ) )}{\partial {x}_{i , j}} \qquad Equation 7$$

In the last line of Equation 7, the function f may correspond to the yield prediction model 130. The function f is a differentiable function (differentiation may be performed with known techniques, e.g., numerical analysis techniques), where the partial derivative of the function f is an instantaneous change rate of the function f with respect to the element x_{i,j} of the embedding vector of the i-th factor of the target wafer.

In addition, (i) the differences (i.e., (x_{i,j}−(Wf_{bg})_{i,j})) between the j-th element of the embedding vector corresponding to the i-th factor of the target wafer and the j-th element of the embedding vectors corresponding to the i-th factor of each background set wafer may be (ii) multiplied by an instantaneous change rate at the point WF_{bg}_{ₖ}+αₖ(WF_{target}−WF_{bgk}) of the function f for the element x_{i,j} of the embedding vector of the target wafer.

Referring to FIG. 5, a point at any position between the process data of the target wafer and the process data of a plurality of fabrication-out wafers included in the background set wafer may correspond to the point WF_{bg}_{ₖ}+αₖ (WF_{target}−WF_{bg}_{ₖ}).

The “Random perturbation” depicted in FIG. 5 may be process of determining a point WF_{bg}_{ₖ}+αₖ (WF_{target}−WF_{bg}_{ₖ}) at which the instantaneous change rate of the function f representing the trained yield prediction model 130 is determined, and αₖ may be randomly determined from a range between 0 and 1.

Referring to FIG. 3 and FIG. 4, the model explainer 140 may determine the contribution for the yield of the i-th factor of the target wafer by summing partial contributions (i.e., the expected gradient of each element in the embedding vector corresponding to the i-th factor) of the i-th factor of the target wafer output from at least one gradient explainer (S140). The contribution Expected Gradientᵢ (WF_{target}) for the yield of the i-th factor of the target wafer may be determined as per Equation 8 below.

$$Expected {Gradient}_{i} ( W {F}_{target} ) = {\sum }_{j = 1}^{d} {\sum }_{k = 1}^{n} ( {x}_{i , j} - {( {WF}_{bg} )}_{i , j} ) \cdot \frac{\partial f ( W {F}_{{bg}_{k}} + {α}_{k} ( W {F}_{t a r g e t} - W {F}_{b {g}_{k}} ) )}{\partial {x}_{i , j}} \qquad Equation 8$$

In some embodiments, the model explainer 140 may determine the contributions, to the yield, of factors of the target wafer and determine primary factors affecting the yield based on the contributions (S150). For example, the model explainer 140 may determine at least one factor with a lower contribution than a predetermined reference among the contributions of each factor as the primary factor of the target wafer. Alternatively, the model explainer 140 may determine at least one factor having the smallest c contributions as the primary factor.

In some embodiments, the model explainer 140 may first determine a suspect factor of a low yield wafer, and then determine contribution of the suspect factor to the yield. For example, the model explainer 140 may determine contributions of factors corresponding to older process equipment, and when the primary factor (having a lower contribution than the predetermined reference) is found from the contributions of the factors corresponding to the older process equipment, there may be no need to determine contributions of other factors. Through such a method, the cost and time required for the model explainer 140 to find the primary factor can be saved. In addition, a lower gradient means less contribution for the low yield. For example, a factor having a large gradient may be determined as the cause of the low yield.

As described above, the yield analysis system according to one or more embodiments may quickly and accurately determine the contributions to the low yields of all factors in the manufacturing process of low yield wafers. By quickly and accurately determining the primary factor that greatly contributed to the low yield of wafers, problematic factors in the semiconductor manufacturing process can be immediately and accurately improved and updated.

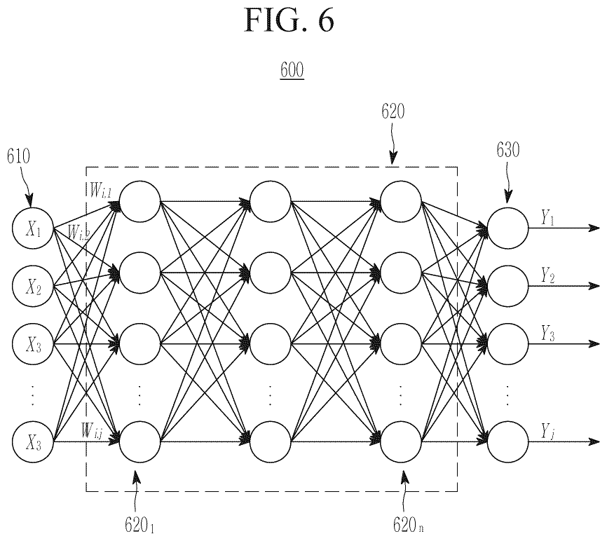

FIG. 6 illustrates a neural network according to one or more embodiments.

Referring to FIG. 6, a neural network 600 according to one or more embodiments may include an input layer 610, a hidden layer 620, and an output layer 630. Each of the input layer 610, the hidden layer 620, and the output layer 630 may include a respective set of nodes, and a strength of connections between nodes may correspond to weight value. This may be referred to as connection weight. The set of nodes included in each of the input layer 610, the hidden layer 620, and the output layer 630 may be fully connected to each other, or less than fully connected. In some embodiments, the number of parameters (weight values and bias values) may be equal to the number of connections within the neural network 600.

The input layer 610 may include a set of input nodes x₁ to xᵢ, and the number of input nodes x₁ to xᵢ may correspond to the number of independent input variables (e.g., factors). For training the neural network 600, a training set may be input to the input layer 610, and if a test dataset is input to the input layer 610 of the trained neural network 600, an inference result (e.g., contribution) may be output from the output layer 630 of the trained neural network 600. In some embodiments, the input layer 610 may have a structure suitable for processing large-scale inputs.

The hidden layer 620 may be disposed between the input layer 610 and the output layer 630, and may include at least one of hidden layer or 620₁ to 620ₙ hidden layers. The output layer 630 may include at least one output node or y₁ to yⱼ output nodes. An activation function may be used in the hidden layer(s) 620 and the output layer 630. In some embodiments, the neural network 600 may be learned by adjusting weight values of connections to/from hidden nodes included in the hidden layer(s) 620.

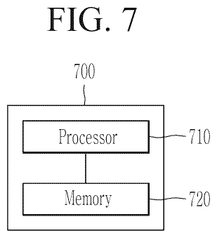

FIG. 7 illustrates an apparatus for analyzing a yield of a wafer according to one or more embodiments.

An apparatus for analyzing a yield of a wafer according to one or more embodiments may be implemented as a computer system (for example, a computer-readable medium). Referring to FIG. 7, the computer system 700 includes one or more processors 710 and a memory 720. The one or more processors 710 is representative of any single processor or any combination of processors, e.g., a CPU, a GPU, an NPU, an accelerator, etc. The memory 720 may be connected to the one or more processors 710 and may store instructions or programs configured to cause the one or more processors 710 to perform a process including any of the methods described above.

The one or more processors 710 may realize functions, stages, or methods in any of the embodiments or examples described herein. An operation of the computer system 700 according to one or more embodiments may be realized by the one or more processors 710. The one or more processors 710 may include a GPU, a CPU, and/or an NPU. When the operation of the computer system 700 is implemented by the one or more processors 710, each task may be divided among the one or more processors 710 according to load. For example, when one processor is a CPU, the other processors may be a GPU, an NPU, an FPGA, and/or a DSP.

The memory 720 may be provided inside/outside the processor, and may be connected to the processor through various means known to a person skilled in the art. The memory represents a volatile or non-volatile storage medium in various forms (but not a signal per se), and for example, the memory may include a read-only memory (ROM) and a random-access memory (RAM). In another way, the memory may be a PIM (processing in memory) including a logic unit for performing self-contained operations.

In another way, some functions (e.g., training the yield predicting model and/or the path generating model, inference by the yield predicting model and/or the path generating model) of the yield predicting device may be provided by a neuromorphic chip including neurons, synapses, and inter-neuron connection modules. The neuromorphic chip is a computer device simulating biological neural system structures, and may perform neural network operations.

Meanwhile, the embodiments are not only implemented through the device and/or the method described so far, but may also be implemented through a program that realizes the function corresponding to the configuration of the embodiment or a recording medium on which the program is recorded, and such implementation may be easily implemented by anyone skilled in the art to which this description belongs from the description provided above. Specifically, methods (e.g., yield predicting methods, etc.) according to the present disclosure may be implemented in the form of program instructions that can be performed through various computer means. The computer readable medium may include program instructions, data files, data structures, etc. alone or in combination. The program instructions recorded on the computer readable medium may be specifically designed and configured for the embodiments. The computer readable recording medium may include a hardware device configured to store and execute program instructions. For example, a computer-readable recording medium includes magnetic media such as hard disks, floppy disks and magnetic tapes, optical recording media such as CD-ROMs and DVDs, and optical disks such as floppy disks. It may be magneto-optical media, ROM, RAM, flash memory, or the like. A program instruction may include not only machine language codes such as generated by a compiler, but also high-level language codes that may be executed by a computer through an interpreter or the like.

The computing apparatuses, the electronic devices, the processors, the memories, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for analyzing a yield of a target wafer, the method comprising:
converting an indication of a category among process data of the target wafer into a first embedding vector comprised of elements and converting indications of the category among process data of background-set wafers into second embedding vectors comprised of elements;
determining partial contributions, with respect to the yield, of the respective elements of the first embedding vector through differentiation with respect to a yield prediction model, the yield prediction model configured to predict yields of wafers from embedding vectors thereof; and
determining a contribution, to the yield, of a factor in a manufacturing process of the target wafer based on combining the partial contributions of the elements of the first embedding vector, the factor corresponding to the indicated category of the target wafer.

2. The method of claim 1, wherein:
the target wafer is a fabrication-out wafer selected based on an actual yield thereof or is an in-fabrication wafer selected based on a predicted yield thereof predicted by the yield prediction model before the manufacture of the target wafer is completed.

3. The method of claim 1, wherein:
the process data of the background-set wafers includes data of fabrication-out wafers having respective yields exceeding a predetermined reference.

4. The method of claim 1, wherein
the converting the indication of the category among the process data of the target wafer into the first embedding vector and converting the indications of the category among the process data of the background-set wafers into the second embedding vectors comprises:
converting the indication of the category among the process data of the target wafer into a first number;
converting the indications of the category among the process data of the background-set wafers into second numbers; and
converting the first number into the first embedding vector and the second numbers into the second embedding vectors using an embedding layer of a neural network model.

5. The method of claim 1, wherein
the determining the partial contributions comprises
calculating an expected gradient of the elements of the first embedding vector based on an instantaneous change rate of the yield prediction model for the elements of the first embedding vector.

6. The method of claim 5, wherein the calculating the expected gradient of the elements of the first embedding vector comprises:
determining points between process data of fabrication-out wafers included in the background-set wafers and the process data of the target wafer; and
determining the instantaneous change rate of the yield prediction model for the elements of the first embedding vector at the points.

7. The method of claim 6, wherein:
the calculating the expected gradient of the elements of the first embedding vector further comprises:
calculating the expected gradient by multiplying a difference between an element of the first embedding vector and corresponding elements of the second embedding vectors of corresponding factors of the fabrication-out wafers by the instantaneous change rate of the yield prediction model.

8. A system for analyzing a yield of a wafer, the system comprising:
an embedding layer configured to convert, into an embedding vector, an indication of a category corresponding to one of multiple factors of a manufacturing process of manufacturing the wafer; and
a model explainer configured to determine contribution, to the yield, of the factor corresponding to the indicated category of the wafer based on a change rate of a yield prediction model.

9. The system of claim 8, further comprising
an encoder configured to convert the indication of the category into a number, and wherein
the embedding layer is further configured to convert the number into the embedding vector.

10. The system of claim 8, wherein:
the wafer is a fabrication-out wafer having an actual yield or is an in-fabrication wafer having a predicted yield predicted by the yield prediction model before the wafer is done being manufactured, and wherein the wafer is selected based on the actual yield or the predicted yield.

11. The system of claim 9, wherein:
the model explainer is further configured to determine partial contributions of elements included in the embedding vector based on the change rate of the yield prediction model and determine contribution of the factors to the yield by combining the partial contributions of the elements.

12. The system of claim 11, wherein:
when determining the partial contributions of the elements,
the model explainer is further configured to calculate an expected gradient of the elements based on an instantaneous change rate of the yield prediction model for the elements.

13. The system of claim 12, wherein:
when calculating the expected gradient of the elements,
the model explainer is further configured to randomly determine points between process data of background-set wafers and the process data of the wafer and determine the instantaneous change rate of the yield prediction model for the elements of the embedding vector corresponding to the factor at the points.

14. The system of claim 13, wherein:
when calculating the expected gradient of the elements,
the model explainer is further configured to calculate the expected gradient by multiplying a difference between the element of the embedding vector corresponding to the factor and corresponding elements of embedding vectors of corresponding factors of the background-set wafers by the instantaneous change rate of the yield prediction model.

15. An apparatus for analyzing a yield of a wafer, the device comprising
one or more processors and memory, wherein the memory stores instructions configured to cause the one or more processors to perform a process including:
converting categorical data among process data of the wafer into an embedding vector;
determining contributions of factors respectively corresponding to the categorical data to the yield based on a change rate of a yield prediction model for the embedding vector; and
determining a primary factor among the factors based on the contributions.

16. The apparatus of claim 15, wherein:
the determining the primary factor among the factors based on the contributions comprises
determining at least one factor having a lower contribution than a predetermined reference among the factor as the primary factor.

17. The apparatus of claim 15, wherein:
the determining the primary factor among the factors based on the contributions comprises
determining at least one factor as the primary factor in an order of smallest contribution.

18. The apparatus of claim 15, wherein
the process further comprises:
converting categorical data among process data of a background set wafer for the wafer into an embedding vector, and
the background set wafer includes data of fabrication-out wafers having respective yields exceeding a predetermined reference.

19. The apparatus of claim 15, wherein:
the converting categorical data among process data of the wafer into an embedding vector comprises:
converting the categorical data in the process data into numeric data; and
converting the numeric data into the embedding vector.

20. The apparatus of claim 15, wherein:
the determining the contributions of factors respectively corresponding to the categorical data to the yield based on a change rate of a yield prediction model for the embedding vector comprises
determining partial contributions of elements included in the embedding vector to the yield based on the change rate of the yield prediction model for the embedding vectors; and
determining the contributions of the factors to the yield by summing the partial contributions of the elements.
